(19) United States
(12) Patent Application Publication
(10) Pub. No.: US 2012/0032030 A1
(43) Pub. Date: Feb. 9, 2012

(54) HIGH LIFT SYSTEM FOR AN AIRPLANE, AIRPLANE SYSTEM AND PROPELLER AIRPLANE HAVING A HIGH LIFT SYSTEM

(75) Inventors: Ina Ruckes, Bremen (DE); Peter Scheffers, Bremen (DE); Michael Willmer, Hamburg (DE); Olaf Spiller, Hude (DE)

(73) Assignee: AIRBUS OPERATIONS GMBH, Hamburg (DE)

(21) Appl. No.: 13/264,393

(22) PCT Filed: Apr. 16, 2010
(86) PCT No.: PCT/EP2010/002358

§ 371 Date: Oct. 14, 2011

(30) Foreign Application Priority Data
Apr. 16, 2009 (DE) 10 2009 017 653.5

(51) Int. Cl. B64C 13/16; B64C 13/26; B64C 13/02; B64C 9/18; B64C 9/20

(52) U.S. Cl. 244/215

(57) ABSTRACT

A high-lift system of an aeroplane is described, including one or more high-lift flaps, an activation device with an activation function for generating adjustment commands for adjusting the adjustment state of the high-lift flaps, and a drive device coupled with the high-lift flaps, which is configured such that on the basis of activation commands the high-lift flaps are adjusted between a refracted adjustment state and an extended adjustment state. The activation function, on the basis of input values, generates adjustment commands and transmits these to the drive device for adjusting the high-lift flaps. The activation function has a function for the automatic retraction of the high-lift flap in flight, which in a flight condition in which the high-lift flap has assumed an extended adjustment state, whilst taking into account an engine thrust and a minimum flight altitude, generates an activation command, in accordance with which the high-lift flap retracts.

The invention concerns a high-lift system of an aeroplane, an aeroplane system and a propeller-driven aeroplane with a high-lift system.

With regard to the ability to control the longitudinal movement of an aeroplane there exists the risk of flow separation on the elevator unit (“tail stall”). The risk of a flow separation on the elevator unit with the consequence of a so-called “negative tail stall” occurs primarily if, in a high-lift configuration (with the landing flaps extended), a strong downthrust must be generated by the elevator unit. In the case of turboprop aeroplanes this effect is enhanced by the effect of the propeller thrust, which is guided via the landing flaps onto the elevator unit.

Normally this effect is compensated for by appropriate design of the elevator unit, so as to fulfil in this manner stability and controllability criteria that are derived from the construction regulations (CS and FAR).

The risk of a “tail stall” depends on dynamic and unsteady components of the angle of incidence of the flight condition of the aeroplane. So-called push-over manoeuvres have been found to be particularly critical, implicitly containing the risk of a tail stall. In these manoeuvres the nose of the aeroplane is pushed downwards by control inputs to the primary control surfaces. The actual hazard arises if in this critical manoeuvre the stall angle of incidence is exceeded, causing a separation of the flow over the tail unit, so that with an appropriate design of the elevator in accordance with the prior art and with an appropriate deflection of the same the aeroplane can no longer be restored to a safe flight attitude.

Accordingly the objective for the tail unit design is to maintain a sufficiently large safety margin from the stall angle (tail stall margin) in predefined flight conditions. However, to determine this value there exists, in addition to the reliability of the aerodynamic calculations, a further uncertainty factor in terms of the effect of icing on the elevator unit. In the construction regulations there are no explicit requirements relating to tail stall. There is, however, a fundamental requirement (CS 25.143 General), that the aeroplane must be reliably controllable and manoeuvrable in all phases of flight. If the risk exists that a negative tail stall can occur during certain manoeuvres, evidence must be provided that the aeroplane, despite flow separation, remains controllable, or has been designed with sufficient safety and reliability such that it cannot enter into a tail stall.

The design measures of known prior art to avoid too great a limitation of the aeroplane with regard to tail stall provide an appropriate increase of the elevator unit surface area, or an increase of the tail unit lever arm, and thus an increase in weight.

The object of the invention is to provide an efficient measure on a high-lift system of an aeroplane, an aeroplane system, and an aeroplane with a high-lift system, with which the risk of flow separation on the elevator unit is minimised and the level of safety and reliability in flight is increased.

This object is achieved with the features of Claim 1. Further forms of embodiment are specified in the subsidiary claims that relate back to Claim 1.

Fundamentally a stabilisation measure, with two different scenarios, can be conducted with the inventive activation function for purposes of generating adjustment commands for purposes of adjusting the adjustment state of the high-lift flaps:
in flight conditions with a high engine thrust and a high landing flap angle; and
in the so-called push over manoeuvre.

The measures provided in accordance with the invention to avoid too large a limitation of the aeroplane with regard to tail stall are to reduce the downward flow onto the elevator unit by means of the design of the activation function for purposes of adjusting the high-lift flaps, in accordance with which an automatic retraction of the landing flaps takes place at certain critical flight conditions. The solution provided in accordance with the invention not only has the advantage that this has no effect on the weight of the aeroplane, but also has the advantage that this can be especially adapted to the specific aerodynamic design of the aeroplane and can be especially optimised for the latter.

The solution provided in the prior art can only compensate for the risk of flow separation on the elevator unit to a limited extent. With the inventive solution, in accordance with which the activation function takes into account an engine thrust limit, and retracts the high-lift flap as a function of the latter if a commanded engine thrust lies above this engine thrust limit, specific aerodynamic effects that can occur with the high-lift flaps extended can be prevented.

In accordance with the invention a high-lift system of an aeroplane is provided, which in particular has:
one or a plurality of high-lift flaps,
an activation device with an activation function for purposes of generating adjustment commands for purposes of adjusting the adjustment state of the high-lift flaps,
a drive device coupled with the high-lift flaps, which is embodied such that on the basis of activation commands this adjusts the high-lift flaps between a retracted adjustment state and an extended adjustment state,
   wherein the activation function, on the basis of input values, generates adjustment commands and transmits these to the drive device for purposes of adjusting the high-lift flaps.

In accordance with an inventive example of embodiment the activation function has in particular a function for the automatic retraction of the high-lift flap in flight, which is embodied such that, at a flight condition in which the high-lift flap has assumed an extended adjustment state, while taking into account an engine thrust and a minimum flight altitude, it generates an activation command, in accordance with which the high-lift flap retracts.

In accordance with a further inventive example of embodiment, or in a particular mode of operation, the activation function has in particular a function for the automatic retraction of the high-lift flap in flight, which is embodied such that, starting from a flight condition in which the high-lift flap has assumed an extended adjustment state of between 80 and 100% of the maximum extended adjustment state, it generates an activation command, in accordance with which the high-lift flap retracts into an extended adjustment state of between 30 and 80% of the maximum extended adjustment state, if predetermined activation function conditions are fulfilled, wherein the conditions are configured in the following manner:
the activation function receives a value for the current engine thrust that has reached an engine thrust limit,
the activation function receives a value for the current flight altitude that transgresses a prescribed flight altitude limit for a minimum flight altitude above the ground, wherein the flight altitude limit is at least 20 m.

These conditions this must be fulfilled within a prescribed time interval in order for the activation function to retract the high-lift flap.

Here the engine thrust limit can be defined as a value that is greater than 50% of the maximum engine thrust.

In accordance with the invention the current engine thrust can in particular be a design value, or an engine thrust that has been derived or measured.

In accordance with a further example of embodiment, or in a particular mode of operation of the invention, provision is made that the function for the automatic retraction of the high-lift flap takes account of the following values:
a current engine thrust,
a value for the current flight altitude,
an adjustment state or a movement of the elevator, or a command signal for the adjustment of the elevator into a state that causes a negative pitch movement.

In accordance with a further example of embodiment, or in a particular mode of operation of the invention, provision is made that the conditions for the generation of the activation command for the retraction of the high-lift flap, are configured in the following manner:
the activation function receives a value for the current engine thrust that exceeds an engine thrust limit, wherein the engine thrust limit is defined as a value that is between 40% and 90% of the maximum engine thrust,
the activation function receives a value for the current flight altitude that transgresses a prescribed flight altitude limit for a minimum flight altitude above the ground, wherein the flight altitude limit is at least 20 m,
the activation function receives a value for the command of the elevator, which exceeds a prescribed elevator adjustment state command limit, wherein the elevator adjustment state command limit is in the range between 50 and 100% of the maximum extended downward adjustment state of the elevator.

The solutions proposed in accordance with the invention allow for detailed adaptation, even at a very late stage of the aeroplane's development, since they do not require any design measures. This fact measurably reduces the development risk and enables flexibility within a practical framework during the aeroplane's development. The reduction of the operating costs of an aeroplane significantly outweighs the increase in the complexity of the software and thus of the one-off costs during the aeroplane's development. The activation function, which is implemented in software, monitors relevant aeroplane parameters, evaluates these and generates a command for the retraction of the landing flaps. In a further example of embodiment of the inventive high-lift system the activation device and the external sources for the values or signals used by the activation device are provided with redundancy.

In accordance with a further aspect of the invention an aeroplane system is provided with an inventive high-lift system.

In accordance with a further aspect of the invention a propeller-driven aeroplane is provided with the inventive aeroplane system and/or with the inventive high-lift system. The propeller-driven aeroplane can in particular be an aeroplane in which the engines driving the propellers are fitted to the wings. Here the propeller-driven aeroplane can in particular be a high-wing aeroplane. The inventive function can advantageously be introduced in these examples of embodiment of the inventive aeroplane, since the risk of flow separation on the elevator unit with the consequence of a so-called “negative tail stall”, in particular in the high-lift configuration (with landing flaps extended), in which a strong downthrust must be generated by the elevator unit, exists to a greater extent in the case of turboprop aeroplanes as a result of the effect of the propeller thrust, which is guided via the landing flaps onto the elevator unit. With the inventive solution it is possible to ensure that the aeroplane operates within flight conditions that have a sufficient safety margin from the condition in which the risk of such flow separation exists. In what follows examples of embodiment of the invention are described with the aid of the accompanying figures, in which:

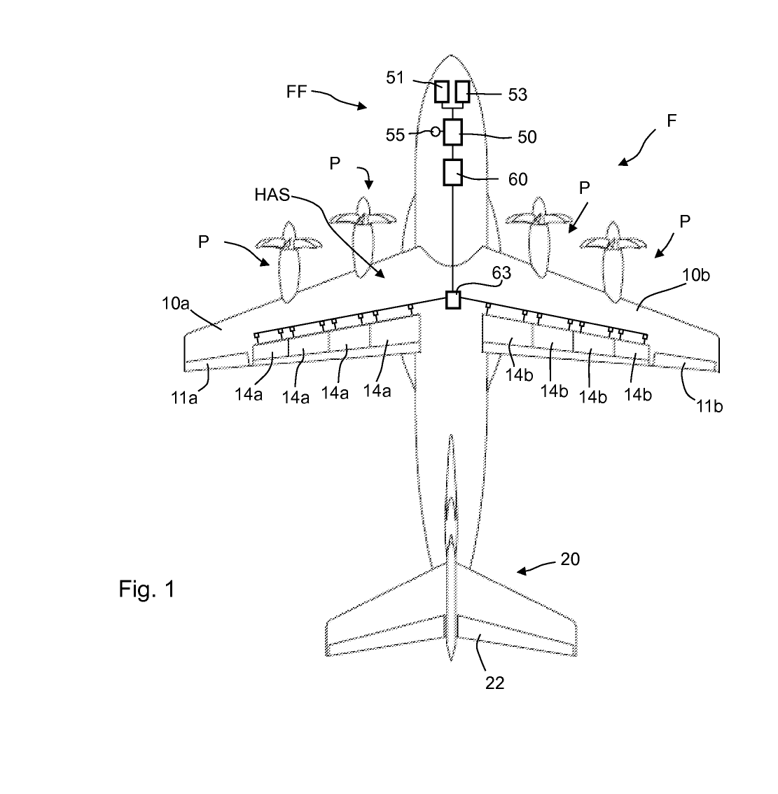

FIG. 1 shows a schematic representation of an aeroplane with a functional representation of a form of embodiment of the inventive high-lift system;

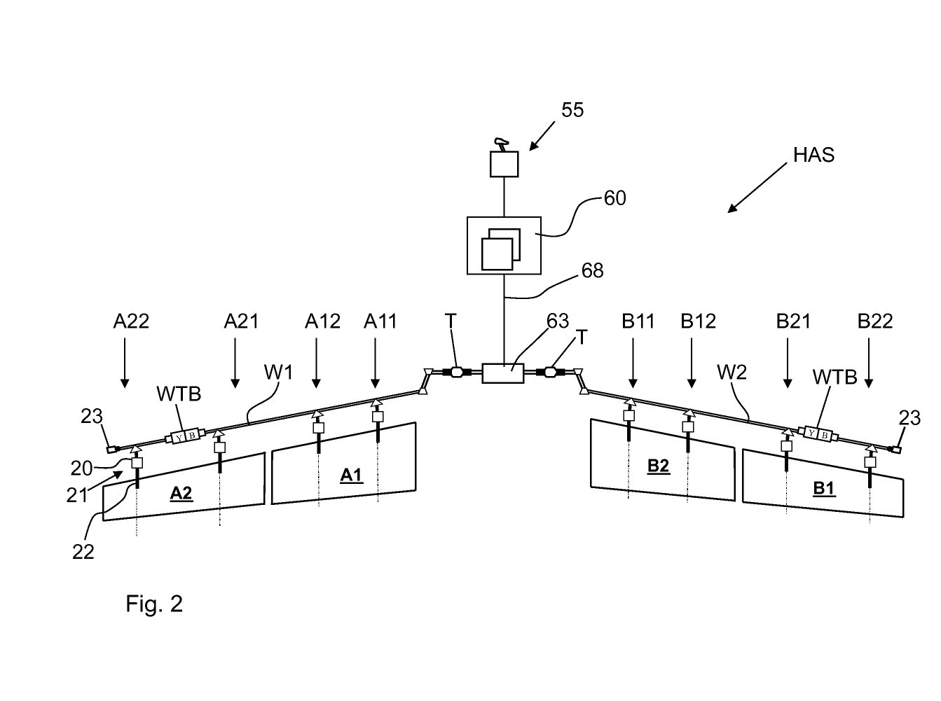

FIG. 2 shows a functional representation of a further example of embodiment of the inventive high-lift system for purposes of adjusting high-lift flaps with a drive device;

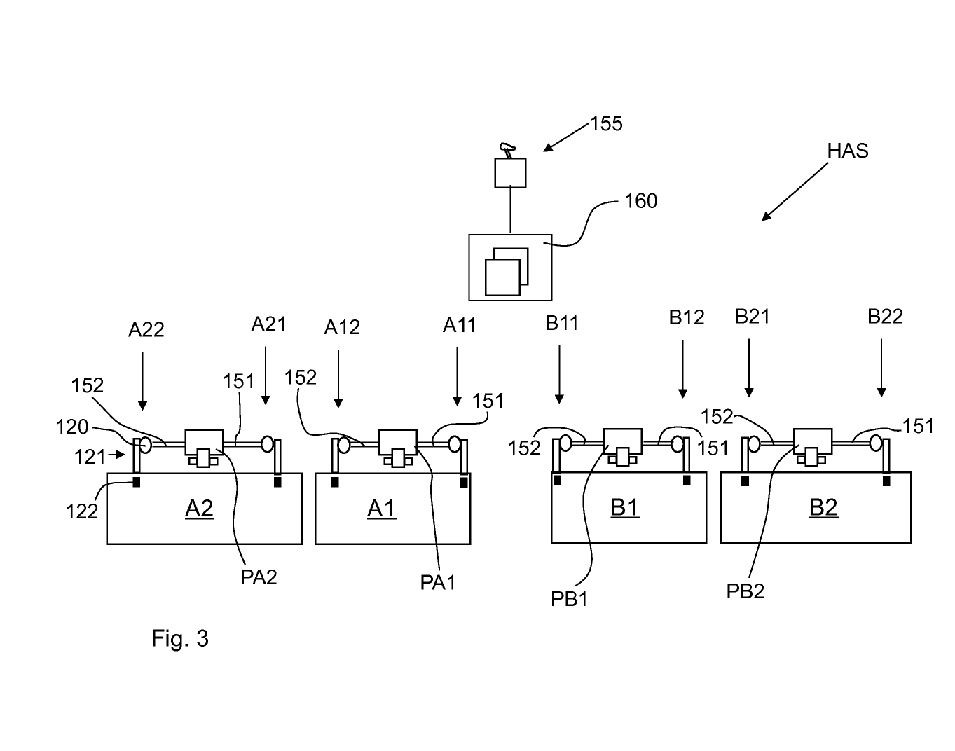

FIG. 3 shows a functional representation of a further example of embodiment of the inventive high-lift system for purposes of adjusting high-lift flaps with a drive device;

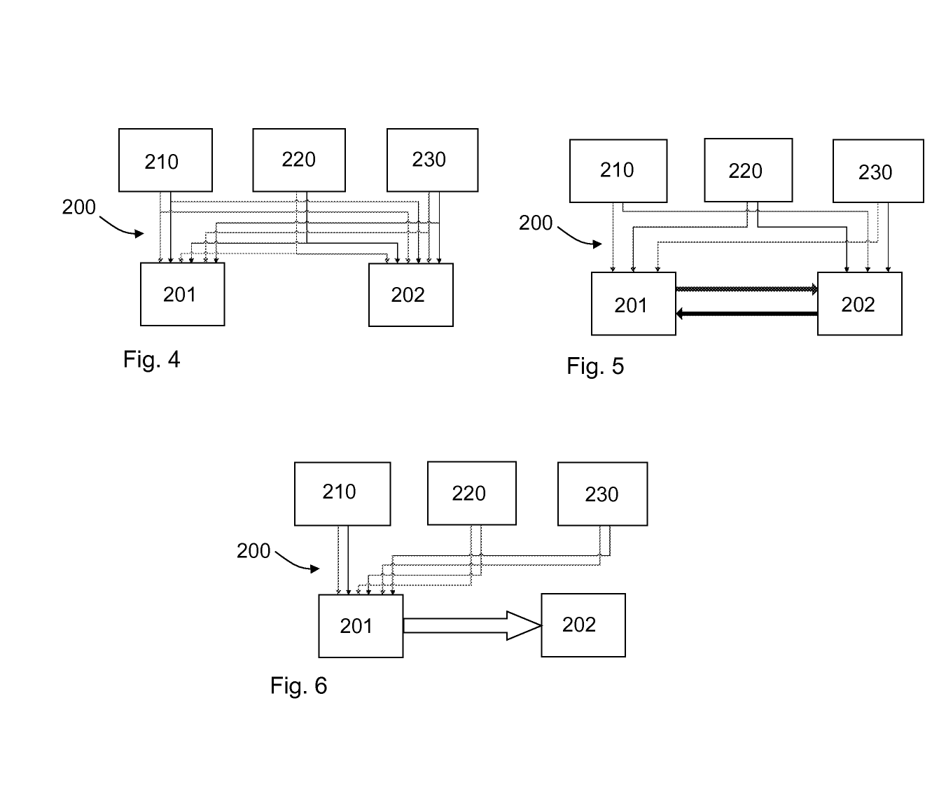

FIG. 4 shows an example of embodiment of a data communications system for purposes of communicating between two activation functions of a high-lift system, an engine control system, a sensor device for purposes of determining the flight altitude above the ground, and a flight control device;

FIG. 5 shows a further example of embodiment of a data communications system for purposes of communicating between two activation functions of a high-lift system, an engine control system, a sensor device for purposes of determining the flight altitude above the ground, and a flight control device.

FIG. 6 shows a further example of embodiment of a data communications system for purposes of communicating between two activation functions of a high-lift system, an engine control system, a sensor device for purposes of determining the flight altitude above the ground, and a flight control device.

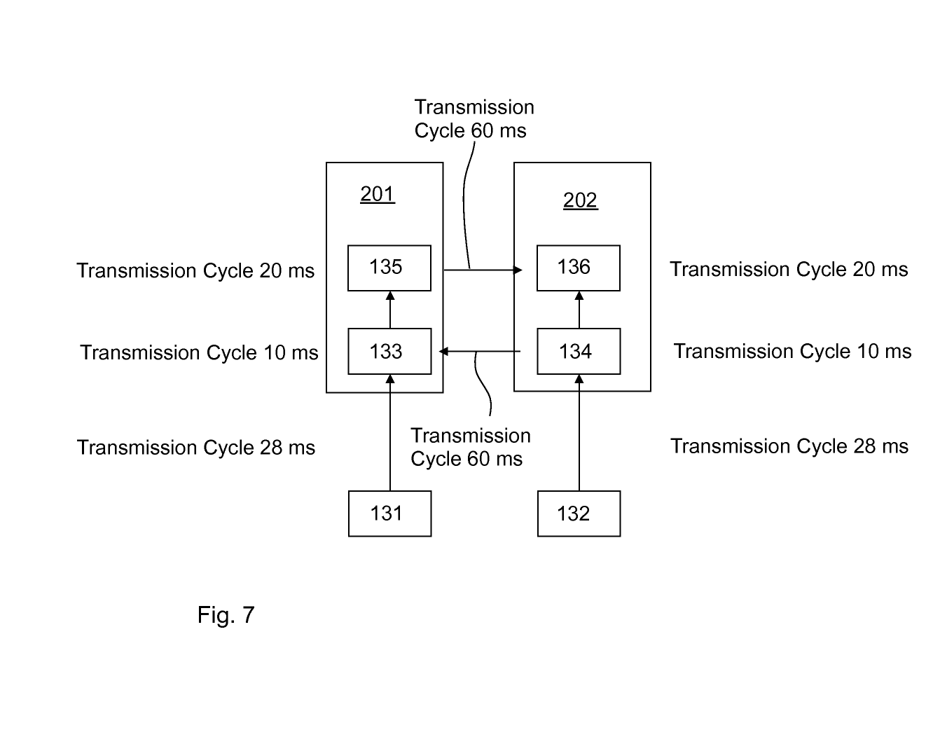

FIG. 7 shows an example of embodiment of a data communications system for purposes of communicating between two activation functions of a high-lift system, and two sensor devices for purposes of determining the flight altitude above the ground.

FIG. 1 shows an example of embodiment of an aeroplane F featuring closed-loop control with two wings 10a, 10b. The wings 10a, 10b in each case have at least one aileron, 11a or 11b respectively, and at least one trailing edge flap 14a, 14b. In each case the wings 10a, 10b can optionally have a number of spoilers and/or leading edge slats. Furthermore the aeroplane F has a vertical tail unit 20 with at least one rudder and one elevator 22. The vertical tail unit 20 can e.g. be designed as a T-tail unit or a cruciform tail unit. The aeroplane F can in particular be a propeller-driven aeroplane with engines P driving the propellers. In the latter case provision can in particular be made that in the propeller-driven aeroplane the engines P driving the propellers are fitted to the wings 10a, 10b, as represented in FIG. 1. Furthermore the propeller-driven aeroplane F can be a high-wing aeroplane.

The aeroplane F or a flight management system FF has a flight control device 50 and also an air data sensor device 51 functionally connected with the flight control device 50 for purposes of registering flight condition data including the barometric altitude, the ambient temperature, the flow velocity, the angle of incidence and the angle of yaw of the aeroplane. Furthermore the aeroplane has an altitude-measuring device 53 for purposes of determining the altitude of the aeroplane F above the ground. Furthermore the aeroplane can have a sensor device with sensors, and in particular inertial sensors, for purposes of registering the rates of turn of the aeroplane (not represented). For this purpose the flight control device 50 has a receiver device for purposes of receiving the sensor values registered by the sensor device and transmitted to the flight control device 50.

Furthermore a control input device 55 is functionally connected with the flight control device 50, with which control commands in the form of design values are generated for purposes of controlling the aeroplane F and transmitted to the flight control device 50. The control input device 55 can have a manual input device. Alternatively or additionally the control input device 55 can also have an autopilot device, which, on the basis of sensor values that are transmitted from sensor devices to the control input device 55, automatically generates control commands in the form of design values for purposes of controlling the aeroplane F, and transmits these to the flight control device 50.

At least one actuator and/or one drive device is assigned to the control surfaces, such as the spoilers, leading edge slats, trailing edge flaps 14a, 14b, the rudder and/or the elevator 22, insofar as one or a plurality of these is provided. In particular provision can be made that one actuator is assigned in each case to one of these control surfaces. A plurality of control surfaces can also be coupled to one actuator, or in each case to an actuator that is driven by a drive device, for purposes of their adjustment. In particular these can be provided for the trailing edge flaps 14a, 14b and—if present—for the leading edge slats 13a, 13b.

The flight control device 50 has a control function, which receives control commands from the control input device 55 and sensor values from the sensor device, and in particular from the air data sensor device 51. The control function is embodied such that it generates adjustment commands for the actuators as a function of the control commands or design values and the registered and received sensor values, and transmits these to the actuators, so that by means of actuation of the actuators the aeroplane F is controlled in accordance with the control commands.

The aeroplane in accordance with the invention, or the inventive high-lift system HAS, has in particular:
one or a plurality of high-lift flaps 14a, 14b on each wing,
a control and monitoring device, or an activation device 60, with an activation function for purposes of generating adjustment commands for purposes of adjusting the adjustment state of the high-lift flaps 14a, 14b,
a drive device 63 coupled with the high-lift flaps 14a, 14b, which is embodied such that this adjusts the high-lift flaps 14a, 14b between a retracted adjustment state and an extended adjustment state on the basis of activation commands,
   wherein the activation function on the basis of input values generates adjustment commands and transmits these to the drive device 63 for purposes of adjusting the high-lift flaps.

An example of embodiment of the high-lift system HAS is described with the aid of FIG. 2, which has four high-lift flaps or landing flaps A1, A2; B1 B2, but which in general has adjustable flaps or aerodynamic bodies on a main wing surface. In FIG. 2 two landing flaps are represented per wing; the latter is not shown in the representation of FIG. 2. In detail are represented: an inner landing flap A1 and an outer landing flap A2 on a first wing, and an inner landing flap B1 and an outer landing flap B2 on a second wing. In the inventive high-lift system less than or more than two landing flaps per wing can also be provided.

The high-lift system HAS is actuated and controlled via a pilot interface, which in particular has an actuation element 56 such as e.g. an actuation lever. The actuation element 56 is part of the control input device 55 or is assigned to the latter, and is functionally coupled with the control and monitoring device 50, or the activation device 60, with the activation function for purposes of generating adjustment commands, or control commands for purposes of adjusting the adjustment state of the high-lift flaps. The control and monitoring device 50, or the activation device 60, transmits control commands via an actuation cable 68 for purposes of activating a central drive unit 7.

In the form of embodiment in accordance with FIG. 2 the drive device 63 is pictured as a central drive device or drive unit, so that the adjustment commands or control commands are transmitted from the control input device 55 via the control and monitoring device 50, or directly from the control input device 55, via an activation cable 68 for purposes of activating a central drive unit 63. The drive unit 63, arranged e.g. centrally, i.e. in the fuselage area, has at least one drive motor, whose output power is transmitted to rotary drive shafts W1, W2. To this end the two rotary drive shafts W1, W2 are in each case coupled to the central drive unit 63 for purposes of actuating the at least one flap per wing A1, A2 or B1, B2 respectively. The two rotary drive shafts W1, W2 are coupled to the central drive unit 63, and are synchronised with one another by means of the latter. On the basis of appropriate control commands the central drive unit 63 sets the rotary drive shafts W1, W2 into rotation for purposes of exercising actuating movements of the respective flap adjustment devices coupled with the latter. A torque limiter T can be integrated into a section of the rotary drive shafts 11, 12 that is located near the drive unit 63. Two adjustment devices are provided on each flap A1, A2 or B1, B2 respectively. Each of the rotary drive shafts W1, W2 is coupled in each case to one of the adjustment devices. In the high-lift system represented in FIG. 2 two adjustment devices are in each case arranged on each flap, and in particular, the adjustment devices A11, A12 and B11, B12 respectively are arranged on the inner flaps A1 and B1, and the adjustment devices A21, A22 and B21, B22 respectively are arranged on the outer flaps A2 and B2. In accordance with an example of embodiment each of the adjustment devices A11, A12, B11, B12, A21, A22, B21, B22 has a step-up gearbox 20, a kinematic adjustment mechanism 21, and also a position sensor 22. The step-up gearbox 20 is mechanically coupled to the respective rotary drive shaft 11, 12 and converts a rotational movement of the respective rotary drive shaft 11, 12 into an adjustment movement of the flap area, which is coupled with the respective adjustment devices A11, A12, B11, B12, A21, A22, B21, B22. On each adjustment device A11, A12, B11, B12, A21, A22, B21, B22 of a flap is arranged a position sensor 22, which determines the current position of the respective flap and transmits this position value via a cable, not represented, to the activation device 60.

An alternative high-lift system in accordance with the invention is represented in FIG. 3. In the form of embodiment in accordance with FIG. 3 the drive device is not constituted—as in the form of embodiment represented in FIG. 2—as a central drive device or drive unit. Instead, each flap A1, A2; B1 B2 can be adjusted in each case by means of an assigned drive device PA1, PA2, PB1, PB2 between a retracted adjustment state and a plurality of extended adjustment states. The actuation system, or high-lift system HAS, represented in FIG. 3 is provided for the adjustment of at least one landing flap on each wing. In the example of embodiment represented in FIG. 3 two aerodynamic bodies or flaps or high-lift flaps are represented per wing; the latter is not shown in the representation of FIG. 3: an inner flap A1 and an outer flap A2 on a first wing, and an inner flap B1 and an outer flap B2 on a second wing. In the example of embodiment of the high-lift system represented less or more than two flaps per wing can also be used.

A drive unit is assigned in each case to each aerodynamic body or each flap, wherein the drive units, PA1 or PB1 respectively, are coupled to the inner flaps A1, B1 and the drive units, PA2 or PB2 respectively, are coupled to the outer flaps A2, B2. The drive devices PA1, PA2, PB1, PB2 can be actuated and controlled automatically, or via a pilot interface with an input device 155, which in particular has an actuation element such as e.g. an actuation lever. The pilot interface 155 is functionally coupled with the control and monitoring device 160. The control and monitoring device 160 is functionally connected with each drive device PA1, PA2, PB1, PB2 , wherein a drive device PA1, PA2, PB1, PB2 is assigned in each case to each aerodynamic body Al, A2; B1, B2.

Two drive connections 151, 152 with drive shafts are coupled to the drive devices PA1, PA2, PB1, PB2; these shafts are driven from the drive devices PA1, PA2, PB1, PB2.

Each of the drive connections 151, 152 is coupled with an adjustment mechanism 121. Each of the drive devices PA1, PA2, PB1, PB2 can in particular have: at least one drive motor, and at least one braking device (not represented), in order to halt and lock in each case the outputs of the first and second drive motor respectively on an appropriate command from the control and monitoring device 160, if an appropriate defect has been detected by the control and monitoring device 160. At least two adjustment devices A11, A12, A21, A22; B11, B12, B21, B22 are arranged on each flap A1, A2 or B1, B2 respectively; these adjustment devices have in each case kinematic flap mechanisms. In each case one of the two drive connections 151, 152 is coupled to each of the adjustment mechanisms A11, A12, A21, A22; B11, B12, B21, B22; in turn these drive connections are coupled in each case to one of the drive devices PA1, PA2, PB1, PB2. In the high-lift system represented in FIG. 3 two adjustment devices are in each case arranged on each flap, and in particular the adjustment devices A11, A12 and B11, B12 respectively are arranged on the inner flaps A1 and B1, and the adjustment devices A21, A22 and B21, B22 respectively are arranged on the outer flaps A2 and B2. Furthermore a step-up gearbox 120, a kinematic adjustment mechanism 121, and also a position sensor 122, can be assigned in particular to each of the adjustment devices A11, A12, B11, B12, A21, A22, B21, B22. In general the step-up gearbox 120 can be implemented in the form of a spindle drive or a rotary actuator. The step-up gearbox 120 is mechanically coupled to the respective rotary drive shaft, 151 or 152 respectively, and converts a rotational movement of the respective rotary drive shaft, 151 or 152 respectively, into an adjustment movement of the flap area, which is coupled with the respective adjustment mechanism.

Furthermore, the control input device 55 of the aeroplane has an engine thrust input device (not represented in the figures), with which engine thrust design values can be commanded, which are transmitted to an engine activation device so as to adjust the engine thrust to be generated by the aeroplane's engines. Here provision can be made that the engine thrust design values are inputted by means of a manual input and/or by means of an autopilot function of the aeroplane system. In accordance with the invention provision is made that the engine thrust input device is functionally connected with the activation device of the high-lift system HAS such that the engine thrust design values, or the measured engine thrust values, are transmitted to the activation device 60, 160.

In accordance with the invention the activation function of the activation device, or control and monitoring device 60, 160, has a function for the automatic retraction of the high-lift flap 14a, 14b in flight, which is embodied such that at a flight condition in which the high-lift flap 14a, 14b has assumed an extended adjustment state, while taking into account an engine thrust and a minimum flight altitude, it generates an activation command in accordance with which the high-lift flap 14a, 14b retracts.

in particular the function for the automatic retraction of the high-lift flap 14a, 14b is embodied such that, starting from a flight condition in which the high-lift flap 14a, 14b has assumed an extended adjustment state between 80 and 100% of the maximum extended adjustment state, it generates an activation and command, in accordance with which the high-lift flap 14a, 14b retracts into an extended adjustment state of at least 10%, and e.g. between 30 and 80%, of the maximum extended adjustment state, if predetermined conditions of the activation function are fulfilled, wherein the conditions are configured in the following manner:
the activation function receives a value for the current engine thrust that has reached an engine thrust limit,
the activation function receives a value for the current flight altitude that transgresses a prescribed flight altitude limit for a minimum flight altitude above the ground, wherein the flight altitude limit is at least 20 m.

These conditions must both be fulfilled within a prescribed period of time, so that these conditions in this respect must be fulfilled simultaneously.

In accordance with a further example of embodiment provision can be made that the engine thrust limit is defined as a value that is greater than 50% of the maximum engine thrust.

In these examples of embodiment of the activation function, the conditions for the retraction of the high-lift flap are independent of a design value for the elevator.

In flight conditions with a high engine thrust and a high landing flap angle the high thrust of the engines in conjunction with the high landing flap angle generates a strong downward flow onto the elevator unit. If under these conditions the nose of the aeroplane is pushed downwards by control inputs, there is a risk of a tail stall. In order to avoid this, the landing flaps are preventively automatically retracted by the required angle. This can only take place at a sufficient flight altitude above the ground, in order to avoid a sudden loss of lift near the ground, and any associated possible contact with the ground. Thus in accordance with the invention at a sufficient flight altitude with high landing flap angles and high engine thrust the landing flap is automatically retracted by the required angle.

In a further example of embodiment of the inventive high-lift system provision is made that the function for the automatic retraction of the high-lift flap 14a, 14b takes account of the following values:
a current engine thrust,
a value for the current flight altitude,
an adjustment state or a movement, or a command of the elevator into a direction that causes a negative pitch movement.

In a further inventive example of embodiment the conditions for the generation of the activation command for the retraction of the high-lift flap can be configured in the following manner:
the activation function receives a value for the current engine thrust that exceeds an engine thrust limit, wherein the engine thrust limit is defined with a value that is between 40% and 90% of the maximum engine thrust,
the activation function receives a value for the current flight altitude that transgresses a prescribed flight altitude limit for a minimum flight altitude above the ground, wherein the flight altitude limit is at least 20 m,
the activation function receives a value for the command of the elevator, which exceeds a prescribed elevator adjustment state command limit, wherein the elevator adjustment state command limit is in the range between 50 and 100% of the maximum extended adjustment state of the elevator downwards, i.e. in the direction commanding an increase of the negative angle of incidence of the aeroplane.

In these examples of embodiment of the inventive solution for the improvement of the flight stability and controllability with extended high-lift flaps, in which:
a current engine thrust,
a value for the current flight altitude,
a adjustment state of the elevator, or a command of the elevator into a direction that causes a negative pitch movement,
   are taken into account, the risk of a “tail stall” under the influence of dynamic and unsteady components of the angle of incidence is evaluated and/or is countered. So-called push-over manoeuvres have been found to be particularly critical, implicitly containing the risk of a tail stall. In these manoeuvres the nose of the aeroplane is pushed downwards by control inputs to the primary control surfaces. The actual hazard arises if in this critical manoeuvre the stall angle of incidence is exceeded, causing a separation of the flow over the tail unit, such that it is no longer possible to control the aeroplane sufficiently with the elevator.

In push-over manoeuvres the nose of the aeroplane is pushed downwards via the control inputs onto the primary control surfaces (elevator), so as rapidly to achieve a high negative angle of incidence for the aeroplane. In these dynamic unsteady manoeuvres at an average to high engine thrust a high negative angle of incidence rapidly arises on the elevator unit. In order here too to avoid actively the negative tail stall with a high landing flap angle, the landing flaps are automatically retracted by the required angle, if the following parameters are processed so as to ensure a safe automatic retraction of the landing flaps in this scenario:
extended adjustment state of the high-lift flap or the aerodynamic body, and e.g. landing flap angle;
movement or extended adjustment state of the elevator and e.g., the control input to the elevator;
a value for the engine thrust;
a flight altitude above the ground.

At a sufficient flight altitude with a high landing flap angle and an average to high engine thrust, and also a high control input to the elevator, the landing flap is automatically retracted by the required angle.

In the inventively provided aeroplane system provision can in particular be made that the values used by the activation function according to the example of embodiment are obtained from the following data sources:
the extended adjustment state of the high-lift flap or the high-lift flaps is determined by means of sensors, which register the current adjustment state of the respective high-lift flap.
for the current engine thrust a respectively commanded engine thrust can be used, so that this is determined as a design value from sensors, which register the current adjustment state of an engine thrust input device. the current engine thrust can alternatively or additionally also be derived from a sensor value that is registered on the engine.
for the flight altitude above the ground, the sensor value of a radar altitude measurement device can be used. Alternatively or additionally the sensor value of an altitude determined by means of a satellite navigation sensor can also be used.
for purposes of determining a value for the movement or extended adjustment state of the elevator, or a command for purposes of adjusting the elevator, a sensor device can be used, which registers on an input means of the input device 55, 155, e.g. a pilot's control column, the adjustment state of the input means for purposes of commanding the movement of the elevator. The sensor device can furthermore have a function, with which the design value for the movement or adjustment state of the elevator, commanded in each case with the input means, is determined, so that in accordance with the invention the design value can also be used as a value for the movement of the elevator in a direction that causes a negative pitch movement.

In the inventive solutions provision can in particular be made that the pilot is informed of the automatic retraction of the landing flaps by means of a display in the cockpit.

In accordance with one example of embodiment of the inventive high-lift system provision is furthermore made that a failure of the function, as a result of internal system defects or a lack of data, is displayed in the cockpit, since then the pilot by appropriate control of the aeroplane must avoid situations with the risk of a tail stall.

In particular the activation function can be implemented with measures to increase the safety and reliability of the high-lift system for the following reasons:
a failure of the function without a display in the cockpit can potentially have catastrophic consequences (negative tail stall on the elevator unit).
a retraction of the landing flaps on the basis of an incorrect embodiment of the function can potentially have dangerous consequences (sudden loss of lift).
a failure of the function with a display in the cockpit will have negligible consequences (additional workload for the pilot).

Since a failure of the function leads to the exclusion of certain aeroplane configurations (e.g. maximum landing flap angle), it is necessary to ensure a high availability of the function. The requirements with regard to safety and reliability and availability have direct consequences on the design of the signal paths (inputs and outputs), and on the design of functions in the controller. A failure of the function without a display in the cockpit can potentially have catastrophic consequences.

In order to achieve a required level of safety and reliability for the whole aeroplane system, which in civil aeroplane construction is defined in terms of a probability of 1*10⁻⁹ per flight hour, the inventive high-lift system can be embodied such that the input signals, which are required for the execution of the inventive activation function, are supplied with redundancy to the activation device with the activation function, in order to increase the reliability of the presence of the input signals. In accordance with an inventive example of embodiment provision is accordingly made to provide the interfaces of the activation device 60, 160 for the transfer:
of an engine thrust, and
a minimum flight altitude
   with redundancy, and with at least dual redundancy.

In addition, provision can also be made that the interface of the activation device 60, 160 for the transfer:
of a command signal to the elevator
   is provided with redundancy, and with at least dual redundancy.

Furthermore in accordance with the invention an aeroplane system with an inventive high-lift system can be provided, in which one or a plurality of the sensor values:
of an engine thrust, and
of a minimum flight altitude, and
of a command signal to the elevator
   are generated by means of dissimilar sensor devices, or similar sensor devices with redundancy, and/or are supplied via transmission lines with redundancy to the activation device 60, 160 with an activation function for purposes of generating adjustment commands for purposes of adjusting the adjustment state of the high-lift flaps 14a, 14b.

If both sources or sensor devices are connected via the same transmission medium with the activation device 60, 160, the risk exists that this transmission medium corrupts both signals at the same time. For this reason, provision is made in accordance with one example of embodiment of the invention that the data are transmitted via separate paths and thereby in particular via different transmission media, or via the same transmission medium, but in the latter case via a physically separate transmission link.

In particular the inventive aeroplane system can have:
a plurality, that is to say, at least two sensor devices for purposes of determining the flight altitude above the ground,
a plurality, that is to say, at least two sensor devices for purposes of determining a current engine thrust or an engine thrust design value.

In an aeroplane system with a high-lift system with an activation device, the function of which, for purposes of the automatic retraction of the high-lift flap 14a, 14b, uses a value for a adjustment state or a movement, or a command signal for purposes of adjusting the elevator in a direction that causes a negative pitch movement, provision can be made that at least two sensor devices are used for purposes of determining such a value.

In the high-lift system in accordance with the invention the actuation speed of the flaps can also be taken into account. Then, in the inventive aeroplane system of the high-lift system, provision can be made that, in the event of a fault, the actuation chain, from the generation of the sensor values to be inputted into the activation function, via the generation of activation commands by means of the activation function, and the actuation of the high-lift flaps in a reduced mode with a reduced actuation speed of the movement of the high-lift flaps, remains available, if at the same time a sufficiently rapid effect for purposes of avoiding the negative tail stall can also be achieved.

For purposes of the automatic traverse of the high-lift flaps 14a, 14b or landing flaps provided in accordance with the invention, the activation function of the activation device 60, 160 executes the following steps:
reception and evaluation of data from external data sources, and in particular from the sensor devices for purposes of determining an extended adjustment state of the high-lift flap, an engine thrust, an altitude above the ground, and/or a adjustment state or a movement, or a command signal for purposes of adjusting the elevator, having the execution of a data input, of a test for fault-free transmission from the respective external source or sensor device, of a test for plausibility, and for exclusion of the presence of faulty data;
a test for the fulfilment of the inventively provided conditions for the automatic movement of the landing flaps;
calculation of the traverse command and forwarding it to the appropriate function, or to the drive device for purposes of activating a traverse sequence for purposes of retracting one or a plurality of aerodynamic bodies or high-lift flaps on both wings.

The reception and evaluation of data from external data sources, and in particular from the sensor devices can be implemented in various ways, in particular with regard to the integrity or security against failure of the aeroplane system with the high-lift system. Examples of embodiment of such an aeroplane system are described in what follows:

In these examples of embodiment the functions of the drive device 63, 163 and in particular the activation function of the latter are multiply embodied. In accordance with one example of embodiment, an activation function for the automatic retraction of the high-lift flap 14a, 14b is implemented in each case on one computer, and a plurality of computers are provided with in each case one such activation function. In the examples of embodiment schematically represented in FIGS. 2 and 3, an activation device, 60 or 160 respectively, in each case has two computers with in each case one activation function, so that the activation function is implemented with dual redundancy. The examples of embodiment of the aeroplane system 200 with a high-lift system with an inventive activation function, which are represented in FIGS. 4, 5 and 6, in each case have: two computers, or a first activation device and a second activation device, 201 or 202 respectively, of the high-lift system, in each case with an activation function, an engine control system 210, in particular for purposes of conversion of design values for the engine into activation commands for purposes of controlling the engine, a sensor device 220 for purposes of determining the altitude of the aeroplane above the ground, and a flight control device 230. The engine control system 210, the sensor device 220 for purposes of determining the altitude of the aeroplane above the ground, and/or the flight control device 230 can in each case be implemented with multiple redundancy. In this case provision can be made that in each case one or a plurality of output signals are generated and outputted by each redundantly configured unit of the engine control system 210, of the sensor device 220 for purposes of determining the altitude of the aeroplane above the ground, and/or of the flight control device 230. Each activation device, 201 or 202 respectively, of the high-lift system receives the input signals required for purposes of execution of the respective activation function with redundancy, i.e. in each case from at least two independent sources via separate connection lines. The connection lines or data links provided in each case can be implemented in various ways, wherein in FIGS. 4, 5 and 6 alternative examples of embodiment of the data links are represented in each case, wherein the respectively represented high-lift system has in each case an activation device, 201 or 202 respectively. In accordance with the invention the high-lift system can also have more than two activation devices, 201 or 202 respectively, in each case. In this case the data links represented are to be modified analogously.

In the linking represented in FIG. 4 of redundantly configured input signals to the activation devices, 201 or 202 respectively, the linking of the external data to each controller takes place via data connections that are separate from one another physically, so that e.g. a connection line is provided in each case from each engine control system 210, from each sensor device 220, and from each flight control device 230, to each activation device 201, 202. By this means it is made possible that each activation device 201, 202 in the event of a failure of another activation device can in each case execute the activation function. With this example of embodiment a high availability of the activation function is achieved.

In the linking of redundantly configured input signals to the activation devices, 201 or 202 respectively, in accordance with FIG. 5, the linking of the external data to each controller takes place via discrete data connections, that is to say via a separate path, i.e. via another transmission medium in each case, or via the same transmission medium, but with a physically separate data connection, wherein from each external source a data connection runs in each case to a first activation device 201 and a second data connection runs to a second activation device 202. In particular in one example of embodiment, in which the aeroplane system in each case has two, or more than two, units of the engine control system 210, of the sensor device 220 for purposes of determining the altitude of the aeroplane above the ground, and/or of the flight control device 230, the data connection can run in each case from one of these units to only one of the activation devices, 201 or 202 respectively. E.g., provision can be made:
that with two redundantly configured units of the engine control system 210 one data connection runs from the first of the redundantly configured units of the engine control system 210 to a first activation device 201, and a further data connection runs from the other redundantly configured unit of the engine control system 210 to a second activation device 202,
that with two redundantly configured units of the sensor device 220 for purposes of determining the altitude of the aeroplane above the ground one data connection runs from one of the redundantly configured units of the sensor device 220 to a first activation device 201, and a further data connection runs from the other redundantly configured unit of the sensor device 220 to a second activation device 202,
that with two redundantly configured units of the flight control device 230 one data connection runs from one of the redundantly configured units of the flight control device 230 to a first activation device 201, and a further data connection runs from the other redundantly configured unit of the flight control device 230 to a second activation device 202.

In this infrastructure of the data links one of the activation devices, 201 or 202 respectively, is only connected with one part of the redundantly configured units, and in particular in each case only with one unit of redundantly configured external sources. This halves the interface complexity for each activation device, 201 or 202 respectively. For purposes of fulfilment of safety and reliability requirements provision is made in accordance with the invention that the data are forwarded to the other activation devices, 201 or 202 respectively, in each case via a discrete data connection line, that is to say, via a separate path, i.e., in each case via another transmission medium, or via the same transmission medium, but with a physically separate data connection. By this means the risk is avoided that the data for both controllers are corrupted by one medium. Each of the activation devices, 201 or 202 respectively, uses the data forwarded in each case from the other activation device, 202 or 201 respectively, in order to check with the aid of the redundancy the plausibility and correctness of the input signals from the other systems. This infrastructure is logical, if execution of the autofunctions is only effective if both activation devices 201 and 202 are operational. In the example of embodiment in accordance with FIG. 5 the interface complexity on the activation devices 201 and 202 is reduced.

In the linking of redundantly configured input signals represented in FIG. 6 to the activation devices, 201 or 202 respectively, the linking of the external data to the first of the activation devices, 201 or 202 respectively, takes place via discrete data connections, that is to say, via a separate path, i.e., in each case via another transmission medium, or via the same transmission medium, but with a physically separate data connection, to the other activation device, so that a connection is provided in each case from each redundantly configured unit of the engine control system 210, of the sensor device 220, and of the flight control device 230 of the first activation device 201, 202, in each case by means of a connection line. The second activation device 202 is coupled in a slave function via a databus to the first activation device 201. The linking of all external data to the activation device, 201 or 202 respectively, is implemented via a master-slave architecture. Here one activation device 201 undertakes the reception and evaluation of all data and forwards the command to execute the function to the other activation device 202. This form of embodiment of the aeroplane system, in particular of the drive device 63, 163 has a reduced security against failure compared with the form of embodiment of FIGS. 4 and 5, since in the event of a failure of the first activation device 201 the activation function can no longer be executed.

In accordance with a further aspect of the invention an evaluation of the data from the external sources takes place with regard to the presence of transmission faults and with regard to plausibility. For the established data paths a simple redundancy of the data via two separate paths is sufficient. AFDX and ARINC429 can be used as the data transmission media or databuses with data transmission protocols. Depending upon the transmission medium various parameters can be called upon to provide evidence concerning transmission faults or usability of the incoming data. Examples for this purpose are:
anticipated transmission rates,
parity,
status bits (marking of the transmitted data as normal, defective, test data, or not analysed).

A fault detection must be confirmed within a fixed time period so as to obtain a robust appraisal of the validity of the data. During this time period invalid input data must be replaced by last valid input data for further processing in the function. In order to check the plausibility of the incoming data, any discrepancy between the same data, which has been transmitted and received via different paths, is evaluated. The maximum allowable discrepancy is composed of the tolerance of the signal and the time offset of the signals via different paths, multiplied by the maximum rate of variation of the signal.

This will be elucidated in what follows using the example of the radar altitude parameter. The sensor device 220 for purposes of determining the altitude of the aeroplane above the ground, e.g. a radar altitude system, is constituted from two radar altitude controllers, which do not work synchronously. In each case one of the redundantly configured activation devices 201 of the high-lift system HAS receives a radar altitude signal from a radar altitude controller. The received signal is transmitted onward to the other activation device 202 in each case. Each activation device, 201 or 202 respectively, can compare the signal forwarded in each case from the other activation device, 202 or 201 respectively, with the signal received directly from the radar altitude system. E.g. the maximum climb rate can be 200 ft/s. The altitude measurement takes place in each case at intervals of 28 ms. At the end of this interval synchronisation takes place and the measured and corrected signal is transmitted.

Thus there is no time delay within the radar altitude controller. FIG. 7 represents the different signal paths and signal transit times (plotted in FIG. 7 in each case) for the radar altitude signal to and within the high-lift system, in that the transit times of the signals, which are transmitted from the radar altitude controllers 131, 132 to a first activation device, 201 or 202 respectively, are represented. From each radar altitude controller 131, 132 a transmission of the measured signal takes place to an input data registration station, 133 or 134 respectively. From there the measured signals are transmitted to a data forwarding station, 135 or 136 respectively. The radar altitude controllers do not run synchronously. One can therefore assume that the maximum time between the value that comes from the first radar altitude controller 131, and the value that is transmitted by the second radar altitude controller 132, varies between 118 ms and 0 ms, in other words, it can have a maximum difference of 118 ms*200 ft/s=23.6 ft≈25 ft. In addition to the tolerance of the radar altitude controller signal a discrepancy of 25 ft must therefore also be allowed for. Any difference between the two received signals that exceeds this value is considered to be a fault. The received data cannot be further used. To obtain robust evidence concerning a defective data source, the discrepancy must also be confirmed several times. Since the maximum time offset of the two signals relative to one another cannot occur each time that the discrepancy is checked, it is necessary to determine the largest time offset that will be present in every case (that is to say, the minimum) over a particular number of cycles with a particular cycle time. In this manner the maximum allowable discrepancy can be reduced. The calculation of the maximum allowable discrepancy of input signals must be carried out for each parameter. In each case it is a function of the signal path and the associated delays, of the maximum variation of the data per unit time, and also of the inaccuracy of the data itself.

In accordance with one example of embodiment of the invention the transmission function is executed with a cycle time that ensures each calculation cycle is executed with new data. The fulfilment of the condition for the intervention of the function must be confirmed several times in order to guarantee a robust performance. However, to guarantee a rapid intervention of the functions into the system the number of confirmations must also be kept as low as possible.

In this example of embodiment of the invention a check is made by the activation function for the automatic retraction of the high-lift flap 14a, 14b, on the one hand of the fulfilment of the conditions with regard to the engine thrust and a minimum flight altitude, and optionally, of the adjustment state or a movement of the elevator 22, or of a command signal for the adjustment of the elevator 22. On the other hand conditions are also checked which are associated with the prerequisites of the function. Here the extension movement can only be commanded by the activation function if items of information concerning the radar altitude are simultaneously transmitted from both radar altitude controllers to the activation device, 201 or 202 respectively, which only deviate from one another by a maximum of a prescribed difference. The information concerning the state of the other activation device of the high-lift system must for this purpose be obtained via the communication between the two activation devices, 201 or 202 respectively.

The modus operandi described in terms of the radar altitude controllers 131, 132 can in accordance with the invention be provided for each redundantly implemented source, that is to say, in particular also for redundantly configured units of an engine control system 210 and/or redundantly configured units of a flight control device 230.

In accordance with the invention a check can also be provided with which it is established that the power supply for the drive is sufficient. If, for example, the hydraulic pressure necessary to supply a hydraulically-driven drive device is not present, no command to retract the flap is generated. If these conditions are no longer fulfilled, provision can be made that retraction of the flaps is only possible as a result of active intervention by the pilot. For this purpose this manual input function must be assigned priority over any other functions that are present. Furthermore a display must be generated for the pilot, which makes visible any intervention of the function, and any reaction on his/her part. After a restart of the controller after a power failure, for example, safe states must prevail in the system. Commands to retract the flaps that were generated before the restart may possibly not be rescinded without awaiting an action from the pilot. For this purpose system information must be evaluated in order to assess whether a function command was pending or not before the restart.

1. A high-lift system of an aeroplane, comprising:
one or a plurality of high-lift flaps,
an activation device with an activation function for purposes of generating adjustment commands for purposes of adjusting the adjustment state of the high-lift flaps,
a drive device coupled with the high-lift flaps, which is configured such that on the basis of activation commands this adjusts the high-lift flaps between a retracted adjustment state and an extended adjustment state,
wherein the activation function on the basis of input values generates adjustment commands and transmits these to the drive device for purposes of adjusting the high-lift flaps,
wherein
the activation function has a function for the automatic retraction of the high-lift flap in flight, which in a flight condition in which the high-lift flap has assumed an extended adjustment state, whilst taking into account an engine thrust and a minimum flight altitude, generates an activation command, in accordance with which the high-lift flap retracts.

2. The high-lift system in accordance with claim 1, wherein the current engine thrust is a design value for the engine thrust.

3. The high-lift system in accordance with claim 1, wherein the activation function has a function for the automatic retraction of the high-lift flap in flight, which is configured such that, starting from a flight condition in which the high-lift flap has assumed an extended adjustment state between 80 and 100% of the maximum extended adjustment state, it generates an activation command, in accordance with which the high-lift flap retracts into an extended adjustment state between 30 and 80% of the maximum extended adjustment state, if predetermined conditions of the activation function are fulfilled, wherein the conditions are configured in the following manner:
the activation function receives a value for the current engine thrust that has reached an engine thrust limit,
the activation function receives a value for the current flight altitude that transgresses a prescribed flight altitude limit for a minimum flight altitude above the ground, wherein the flight altitude limit is at least 20 m.

4. The high-lift system in accordance with claim 3, wherein the engine thrust limit is defined as a value that is greater than 50% of the maximum engine thrust.

5. The high-lift system in accordance with claim 1, wherein the function for the automatic retraction of the high-lift flap takes into account the following values:
a current engine thrust,
a value for the current flight altitude,
a adjustment state or a movement of the elevator, or a command signal for purposes of adjusting the elevator into a state that causes a negative pitch movement.

6. The high-lift system in accordance with claim 5, wherein the conditions for the generation of the activation command for the retraction of the high-lift flap are configured in the following manner:
the activation function receives a value for the current engine thrust that exceeds an engine thrust limit, wherein the engine thrust limit is defined as a value that is between 40% and 90% of the maximum engine thrust,
the activation function receives a value for the current flight altitude that transgresses a prescribed flight altitude limit for a minimum flight altitude above the ground, wherein the flight altitude limit is at least 20 m,
the activation function receives a value for a adjustment state or a movement, or a command of the elevator, which exceeds a prescribed elevator adjustment state command limit, wherein the elevator adjustment state command limit is in the range between 50 and 100% of the maximum extended adjustment state of the elevator in a direction that causes a negative pitch movement.

7. The high-lift system in accordance with claim 1, wherein the interfaces of the activation device for the transfer:
of an engine thrust, and
a minimum flight altitude
are provided with redundancy.

8. The high-lift system in accordance with claim 7, wherein the interface of the activation device for the transfer of an adjustment state or a movement of the elevator, or a command signal for purposes of adjusting the elevator, is provided with redundancy.

9. An aeroplane system with a high-lift system in accordance with claim 1.

10. A propeller-driven aeroplane with a high-lift system in accordance with one of the claims 1.

11. A propeller-driven aeroplane with an aeroplane system in accordance with claim 9.

12. The propeller-driven aeroplane in accordance with claim 10, wherein on the propeller-driven aeroplane the engines driving the propellers are fitted to the wings.

13. The propeller-driven aeroplane in accordance with claim 10, characterised in that the propeller-driven aeroplane is a high wing aeroplane.
